(19) United States
(12) Patent Application Publication
(10) Pub. No.: US 2019/0391037 A1
(43) Pub. Date: Dec. 26, 2019

(54) A PERFORMANCE ALARMING METHOD FOR LONG-SPAN BRIDGE GIRDER CONSIDERING TIME-VARYING EFFECTS

(71) Applicant: Dalian University of Technology, Dalian, Liaoning (CN)

(72) Inventors: Tinghua YI, Dalian, Liaoning (CN); Haibin HUANG, Dalian, Liaoning (CN); Hongnan LI, Dalian, Liaoning (CN)

(21) Appl. No.: 16/342,922

(22) PCT Filed: Mar. 23, 2018
(86) PCT No.: PCT/CN2018/080224

§ 371 Date: Apr. 17, 2019

(30) Foreign Application Priority Data
Dec. 28, 2017 (CN) 201711458798.4

(51) Int. Cl. G01M 5/00; G06F 17/50

(52) U.S. Cl. CPC G01M 5/0008; G06F 2217/80; G06F 17/5009; G01M 5/0041

(57) ABSTRACT

Health monitoring for civil structures, and a performance alarming method for long-span bridge girder considering time-varying effects. First, establish accurate relationship model between temperature and strain fields to eliminate the temperature effect in the girder strain; second, build principal component analysis model for the girder strain after eliminating temperature effect to further eliminate the effects of wind and vehicle loads. Then, construct the performance alarming index and determine its reasonable threshold for the strain after eliminating the effects of temperature, wind and vehicle loads. Finally, construct the performance degradation locating index based on the contribution analysis.

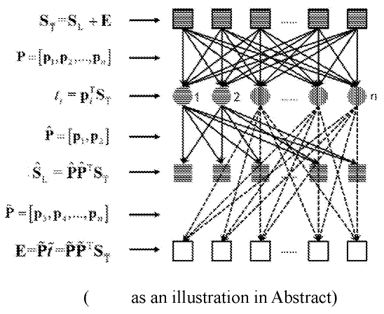

### TECHNICAL FIELD

The present invention belongs to the technical field of health monitoring for civil structures, and a performance alarming method for long-span bridge girder considering time-varying effects is proposed.

### BACKGROUND

The strain response can reflect the service performance of bridge girder, and therefore, the strain measurement plays an important role in bridge health monitoring. Almost all bridge monitoring systems deploy strain sensors on critical sections of the main-girder to grasp the changes of their strain responses. When the main-girder is damaged, its strain response will increase correspondingly. Among the long-term service process of the bridge, however, the girder strain will also be influenced by the time-varying effects of temperature, wind and vehicles. If the damage of the main-girder is slight, the corresponding strain increment will be relatively small. Therefore, it will be neglected for the existence of the relatively large strain responses caused by the time-varying effects. In order to provide a reliable performance alarming for the bridge girder, the time-varying effects of the girder strain responses should be eliminated.

Previous research results show that, when bridge girder is in its normal operating state, temperature is the main factor causing the girder strain while wind and vehicle loads are the secondary factors. The influence of temperature on the girder strain is easy to quantify, therefore a relationship model between girder temperature and strain fields can be established directly through the monitoring data. The temperature effect in the girder strain can then be eliminated based on the relationship model. However, the influence of wind and vehicle loads on the girder strain is difficult to quantify. A principal component analysis model is established for the girder strain in which the temperature effect is eliminated, and the first two principal components can be extracted to eliminate the effects of wind and vehicle loads in the girder strain. Then, a performance alarming index which is not affected by time-varying effects can be constructed for the girder strain after eliminating the influence of temperature, wind and vehicles, and the corresponding alarming threshold can be determined. In addition, the location of girder performance degradation can also be identified based on the contribution analysis.

### SUMMARY

The present invention aims to propose an eliminating method for the time-varying effects in the bridge girder strain, based on that a performance alarming index and a performance degradation locating index are constructed. The technical solution of the present invention is as follows: first, establish accurate relationship model between temperature and strain fields to eliminate the temperature effect in the girder strain; second, build principal component analysis model for the girder strain after eliminating temperature effect to further eliminate the effects of wind and vehicle loads; then, construct the performance alarming index and determine its reasonable threshold for the strain after eliminating the effects of temperature, wind and vehicle loads; finally, construct the performance degradation locating index based on the contribution analysis.

A performance alarming method for long-span bridge girder considering time-varying effects, the specific steps of which are as follows:

Step 1: Eliminate the Temperature Effect in the Girder Strain

(1) Let T=[T₁, T₂, . . . , Tₘ]^{T} represents a measurement sample of m girder temperature measurement points in the bridge health monitoring system, and S=[S₁, S₂, . . . , Sₙ]^{T} represents a measurement sample of n girder strain measurement points, calculate the covariance and cross-covariance matrices for the temperature and strain monitoring data as follows:

$${R}_{TT} = \frac{1}{l - 1} {\sum }_{t = 1}^{l} \{ T ( t ) - \overline{T} \} {\{ T ( t ) - \overline{T} \}}^{T}$$

$${R}_{SS} = \frac{1}{l - 1} {\sum }_{t = 1}^{l} \{ S ( t ) - \overline{S} \} {\{ S ( t ) - \overline{S} \}}^{T}$$

$${R}_{TS} = \frac{1}{l - 1} {\sum }_{t = 1}^{l} \{ T ( t ) - \overline{T} \} {\{ S ( t ) - \overline{S} \}}^{T}$$

$${R}_{ST} = \frac{1}{l - 1} {\sum }_{t = 1}^{l} \{ S ( t ) - \overline{S} \} {\{ T ( t ) - \overline{T} \}}^{T}$$

where T(t) represents the tth temperature measurement sample; T̅ represents the mean-vector of temperature data; S(t) represents the tth strain measurement sample; S̅ represents the mean-vector of strain data; l represents the number of samples; R_{TT} represents the covariance matrix of temperature data; R_{SS} represents the covariance matrix of strain data; R_{TS} represents the cross-covariance matrix of temperature and strain data; R_{ST} represents the cross-covariance matrix of strain and temperature data;

(2) Establish canonical correlation analysis model for the temperature and strain data through eigenvalue decomposition:

R_{TT}⁻¹R_{TS}R_{SS}⁻¹R_{ST}=UΓU^{T}

R_{SS}⁻¹R_{ST}R_{TT}⁻¹R_{TS}=VΓT^{T}

where U=[u₁, u₂, . . . uₖ] and V=[v₁, v₂, . . . , vₖ] are eigenvector matrices; Γ is a diagonal eigenvalue matrix; k=min (m, n) is the number of non-zero solutions;

(3) Define canonically correlated temperature:

T_{c,i}=uᵢ^{T}T

where T_{c,i} represents the ith (i=1, 2, . . . , k) canonically correlated temperature; it should be noted that, the correlation between the ith canonically correlated temperature and the strain data is stronger than that between the (i+1)th canonically correlated temperature and the strain data;

(4) Select the first q canonically correlated temperature as independent variables using cross-validation method, and establish a relationship model between temperature and strain fields as follows:

$$[ \begin{matrix}{\hat{S}}_{T , 1} \\ {\hat{S}}_{T , 2} \\ ⋮ \\ {\hat{S}}_{T , n}\end{matrix} ] = [ \begin{matrix}{β}_{1 , 1} & {β}_{1 , 2} & … & {β}_{1 , q} \\ {β}_{2 , 1} & {β}_{2 , 2} & … & {β}_{2 , q} \\ ⋮ & ⋮ & ⋱ & ⋮ \\ {β}_{n , 1} & {β}_{n , 2} & … & {β}_{n , q}\end{matrix} ] [ \begin{matrix}{T}_{c , 1} \\ {T}_{c , 2} \\ ⋮ \\ {T}_{c , q}\end{matrix} ] + [ \begin{matrix}{β}_{1 , 0} \\ {β}_{2 , 0} \\ ⋮ \\ {β}_{n , 0}\end{matrix} ]$$

where Ŝ_{T,j} represents the estimated strain of the jth (j=1, 2, . . . , n) strain measurement point caused by temperature effect; β represents the regression coefficient;

(5) Let Ŝ_{T}=[Ŝ_{T,1}, Ŝ_{T,2}, . . . , Ŝ_{T,n}]^{T} represent the estimated strain of all strain measurement points caused by temperature effect, the temperature effect can be eliminated from the girder strain through the following equation:

S_{T̅}=S−Ŝ_{T}

where S_{T}=[S_{T,1}, S_{T,2}, . . . , S_{T,n}]^{T} represents the strain of all strain measurement points after eliminating temperature effect; it should be noted that the mean vector of the girder strain data after eliminating temperature effect is a zero-vector.

Step 2: Eliminate the Wind and Vehicle Load Effects in the Girder Strain

(6) Establish principal component analysis model for the girder strain data after eliminating the temperature effect through eigenvalue decomposition, as follows:

R=E{S_{T}S_{T}^{T}}=PΛP^{T}

where E{⋅} represents expectation operator; R represents the covariance matrix of S_{T}; Λ=diag(λ₁, λ₂, . . . , λₙ) represents a diagonal matrix containing all n eigenvalues; P=[p₁, p₂, . . . , pₙ] represents an orthonormal matrix containing all n eigenvectors;

(7) Define the principal subspace and the error subspace:

\hat{P}=[p₁,p₂]

\tilde{P}=[p₃,p₄, . . . ,pₙ]

where \hat{P} represents the principal subspace; \tilde{P} represents the error subspace;

(8) Reconstruct the wind and vehicle load effects through principal subspace and calculate the reconstruction error through error subspace:

Ŝ_{L}\hat{P}\hat{P}^{T}S_{T̅},

E=\tilde{P}\tilde{P}^{T}S_{T̅}

where Ŝ_{L} represents the reconstructed girder strain induced by wind and vehicle loads; E represents the reconstruction error which is not affected by temperature, wind and vehicle loads.

Step 3: Construct Performance Alarming Index and Determine its Threshold Value

(9) Aiming at the reconstruction error E, construct the performance alarming index of main-girder which is not affected by time-varying loads, i.e., the Mahalanobis distance defined in the error subspace:

Tₑ²=S_{T̅}^{T}(\tilde{P}\tilde{Λ}⁻¹\tilde{P}^{T})S_{T̅}

where \tilde{Λ}=diag (λ₃, λ₄, . . . , λₙ) represents a diagonal matrix containing the last n−2 eigenvalues; Tₑ² represents the performance alarming index of main-girder;

(10) Through the kernel density estimation method, the probability density function of alarming index Tₑ² (under normal condition) can be fitted, based on that its cumulative density function can also be calculated; correspondingly; the inverse cumulative density function can be further calculated; for a given significance level α, its corresponding confidence level is 1−α, and the threshold of alarming index Tₑ² can be determined as:

T_{e,lim}²=F⁻¹(1−α)

where F⁻¹(⋅) represents the inverse cumulative density function of the alarming index; T_{e,lim}² represents the threshold of the alarming index; when the alarming index exceeds its corresponding threshold, it can be judged that the performance of the main-girder is degraded.

Step 4: Construct the Performance Degradation Locating Index

(11) Let Φ=\tilde{P}\tilde{Λ}⁻¹\tilde{P}^{T}, based on the contribution analysis theory, the alarming index can be expressed as the sum of each contribution value corresponding to each strain measurement point:

$${T}_{e}^{2} = {\sum }_{j = 1}^{n} {S}_{\overline{T}}^{T} Φ ( {ξ}_{j} {ξ}_{j}^{T} ) {S}_{\overline{T}}$$

where ξⱼ is n-dimensional column vector, its jth element is equal to 1 while others are equal to 0;

(12) Define the performance degradation locating index as the contribution value corresponding to each strain measurement point:

CONT(j)=S_{T̅}^{T}Φ(ξⱼξⱼ^{T})S_{T̅}

where CONT(j) represents the contribution value corresponding to the jth (j=1, 2, . . . , n) strain measurement point, a large value always indicate that the location of the jth strain measurement point is degraded.

The present invention has the beneficial effect that: by eliminating the time-varying effect in the girder strain, a more reliable performance alarming index can be obtained, and the location of strain measurement points where performance degradation occurs can also be identified.

### FIGURE ILLUSTRATION

The sole FIGURE describes elimination process of wind and vehicle load effects through principal component analysis.

### DETAILED DESCRIPTION

The following details is used to further describe the specific implementation process of the present invention.

The monitoring data of girder temperatures and strains, acquired during 60 days, from a long-span bridge is used to verify the validity of the present invention. The monitoring data acquired during the first 50 days is used as training dataset, which represents the intact state of main-girder; whereas the monitoring data acquired during the last 10 days is used as testing dataset, which represents the unknown state of main-girder.

The detailed implementation process is as follows:

(1) Establish a canonical correlation analysis model for the temperature and strain data in the training dataset, and then calculate the canonically correlated temperatures; determine the number of canonically correlated temperatures using the cross-validation method to establish the relationship model between the temperature and strain fields for the main girder, and thus eliminating the temperature effect in girder strain; build the principal component analysis model for the girder strain data after eliminating the temperature effect, so that the wind and vehicle load effects can be eliminated (the process is shown in the FIGURE); Aiming at the girder strain after eliminating the time-varying effects of temperature, wind and vehicle loads, calculate the performance alarming index of main-girder under normal operating condition, and determine the reasonable threshold using the kernel density estimation method.

(2) Simulate performance degradation of main-girder in the testing dataset; first, feed the testing data into relationship model between the girder temperature and strain fields to eliminate the temperature effect; second, feed the strain data after eliminating the temperature effect into the principal component analysis model to eliminate wind and vehicle load effects; then, calculate the performance alarming index of main-girder under the unknown operating condition and compare it with the threshold, trigger a performance alarm if the alarming index exceeds its threshold; finally, compute the performance degradation locating index to identify the specific locations where performance degradation occurs; the results show that, when the performance degradation degree of different girder sections reaches 8% to 12%, the present invention can successfully trigger alarms and identify the specific location where performance degradation occurs.

We claims:

1. A performance alarming method for long-span bridge girder considering time-varying effects, wherein the specific steps are as follows:
step 1: eliminate the temperature effect in the girder strain
(1) let T=[T₁, T₂, . . . , Tₘ]^{T} represents a measurement sample of m girder temperature measurement points in the bridge health monitoring system, and S=[S₁, S₂, . . . , Sₙ]^{T} represents a measurement sample of n girder strain measurement points, calculate the covariance and cross-covariance matrices for the temperature and strain monitoring data as follows:
$${R}_{TT} = \frac{1}{l - 1} {\sum }_{t = 1}^{l} \{ T ( t ) - \overline{T} \} {\{ T ( t ) - \overline{T} \}}^{T}$$
$${R}_{SS} = \frac{1}{l - 1} {\sum }_{t = 1}^{l} \{ S ( t ) - \overline{S} \} {\{ S ( t ) - \overline{S} \}}^{T}$$
$${R}_{TS} = \frac{1}{l - 1} {\sum }_{t = 1}^{l} \{ T ( t ) - \overline{T} \} {\{ S ( t ) - \overline{S} \}}^{T}$$
$${R}_{ST} = \frac{1}{l - 1} {\sum }_{t = 1}^{l} \{ S ( t ) - \overline{S} \} {\{ T ( t ) - \overline{T} \}}^{T}$$
where T(t) represents tth temperature measurement sample; T̅ represents mean-vector of temperature data; S(t) represents tth strain measurement sample; S̅ represents mean-vector of strain data; l represents number of samples; R_{TT} represents a covariance matrix of temperature data; R_{SS} represents a covariance matrix of strain data; R_{TS} represents a cross-covariance matrix of temperature and strain data; R_{ST} represents a cross-covariance matrix of strain and temperature data;
(2) establish canonical correlation analysis model for temperature and strain data through eigenvalue decomposition:
R_{TT}⁻¹R_{TS}R_{SS}⁻¹R_{ST}=UΓU^{T}
R_{SS}⁻¹R_{ST}R_{TT}⁻¹R_{TS}=VΓV^{T}
where U=[u₁, u₂, . . . uₖ] and V=[v₁, v₂, . . . , vₖ] are eigenvector matrices; Γ is a diagonal eigenvalue matrix; k=min(m,n) is the number of non-zero solutions;
(3) define canonically correlated temperature:
T_{c,j}=uᵢ^{T}T
where T_{c,i} represents the ith (i=1, 2, . . . , k) canonically correlated temperature; it should be noted that, the correlation between the ith canonically correlated temperature and the strain data is stronger than that between the (i+1) th canonically correlated temperature and strain data;
(4) select the first q canonically correlated temperature as independent variables using cross-validation method, and establish a relationship model between temperature and strain fields as follows:
$$[ \begin{matrix}{\hat{S}}_{T , 1} \\ {\hat{S}}_{T , 2} \\ ⋮ \\ {\hat{S}}_{T , n}\end{matrix} ] = [ \begin{matrix}{β}_{1 , 1} & {β}_{1 , 2} & … & {β}_{1 , q} \\ {β}_{2 , 1} & {β}_{2 , 2} & … & {β}_{2 , q} \\ ⋮ & ⋮ & ⋱ & ⋮ \\ {β}_{n , 1} & {β}_{n , 2} & … & {β}_{n , q}\end{matrix} ] [ \begin{matrix}{T}_{c , 1} \\ {T}_{c , 2} \\ ⋮ \\ {T}_{c , q}\end{matrix} ] + [ \begin{matrix}{β}_{1 , 0} \\ {β}_{2 , 0} \\ ⋮ \\ {β}_{n , 0}\end{matrix} ]$$
where Ŝ_{T,j} represents the estimated strain of the jth (j=1, 2, . . . , n) strain measurement point caused by temperature effect; β represents the regression coefficient;
(5) let Ŝ_{T}=[Ŝ_{T,1}, Ŝ_{T,2}, . . . , Ŝ_{T,n}]^{T} represent the estimated strain of all strain measurement points caused by temperature effect, temperature effect can be eliminated from the girder strain through following equation:
S_{T̅}=S−Ŝ_{T}
where S_{T̅}=[S_{T̅,1}, S_{T̅,2}, . . . , S_{T̅,n}]^{T} represents the strain of all strain measurement points after eliminating temperature effect; it should be noted that the mean vector of the girder strain data after eliminating temperature effect is a zero-vector;
step 2: eliminate wind and vehicle load effects in the girder strain
(6) establish principal component analysis model for girder strain data after eliminating the temperature effect through eigenvalue decomposition, as follows:
R=E{S_{T̅}S_{T̅}^{T}}=PΛP^{T}
where E{⋅} represents expectation operator; R represents a covariance matrix of S_{T̅}; Λ=diag (λ₁, λ₂, . . . , λₙ) represents a diagonal matrix containing all n eigenvalues; P=[p₁, p₂, . . . pₙ] represents an orthonormal matrix containing all n eigenvectors;
(7) define the principal subspace and the error subspace:
\hat{P}=[p₁,p₂]
\tilde{P}=[p₃,p₄, . . . ,pₙ]
where \hat{P} represents the principal subspace; \tilde{P} represents the error subspace;
(8) reconstruct wind and vehicle load effects through principal subspace and calculate the reconstruction error through error subspace:
Ŝ_{L}=\hat{P}\hat{P}^{T}S_{T̅}
E=\tilde{P}\tilde{P}^{T}S_{T̅}
where Ŝ_{L} represents the reconstructed girder strain induced by wind and vehicle loads; E represents the reconstruction error which is not affected by temperature, wind and vehicle loads;
step 3: construct performance alarming index and determine its threshold value
(9) aiming at reconstruction error E, construct performance alarming index of main-girder which is not affected by time-varying loads, i.e., the Mahalanobis distance defined in the error subspace:
Tₑ²S_{T̅}^{T}(\tilde{P}\tilde{Λ}⁻¹\tilde{P}^{T})S_{T̅}
where \tilde{Λ}=diag (λ₃, λ₄, . . . , λₙ) represents a diagonal matrix containing the last n−2 eigenvalues; Tₑ² represents the performance alarming index of main-girder;
(10) through a kernel density estimation method, a probability density function of alarming index Tₑ² (under normal condition) can be fitted, based on that its cumulative density function can also be calculated; correspondingly; the inverse cumulative density function can be further calculated; for a given significance level α, its corresponding confidence level is 1−α, and a threshold of alarming index Tₑ² can be determined as:
T_{e,lim}²=F⁻¹(1−α)
where F⁻¹(⋅) represents the inverse cumulative density function of the alarming index; T_{e,lim}² represents the threshold of the alarming index; when the alarming index exceeds its corresponding threshold, it can be judged that the performance of the main-girder is degraded;
step 4: construct the performance degradation locating index
(11) let Φ=\tilde{P}\tilde{Λ}⁻¹\tilde{P}^{T}, based on the contribution analysis theory, the alarming index can be expressed as the sum of each contribution value corresponding to each strain measurement point:
$${T}_{e}^{2} = {\sum }_{j = 1}^{n} {S}_{\overline{T}}^{T} Φ ( {ξ}_{j} {ξ}_{j}^{T} ) {S}_{\overline{T}}$$
where ξⱼ is n-dimensional column vector, its jth element is equal to 1 while others are equal to 0;
(12) define the performance degradation locating index the contribution value corresponding to each strain measurement point:
CONT(j)=S_{T̅}^{T}Φ(ξⱼξⱼ^{T})S_{T̅},
where CONT(j) represents the contribution value corresponding to the jth (j=1, 2, . . . , n) strain measurement point, a large value always indicate that the location of the jth strain measurement point is degraded.
